(19) United States
(12) Patent Application Publication
(10) Pub. No.: US 2008/0188596 A1
(43) Pub. Date: Aug. 7, 2008

(54) High Solid Pigment Ink and Process for Thermal Inkjet Printing

(76) Inventors: Charles E. Akers, Lexington, KY (US); Xiaorong Cai, Lexington, KY (US); Jun Li, Lexington, KY (US); Ajay Kanubhai Suthar, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/537,008

(22) Filed: Sep. 29, 2006

(51) Int. Cl. C09D 11/10; B05D 5/00

(52) U.S. Cl. 524/104; 524/457; 524/394; 427/256

(57) ABSTRACT

The present invention relates to ink compositions. More particularly, the ink compositions contain the basic ingredients of pigment inks for inkjet applications. Those ingredients are pigment dispersions, humectants, surfactants/penetrants, biocide, and balance water. In addition to these ingredients, the ink compositions of the present invention contain from about 2.5% to about 7.5% of a latex binder emulsion. The latex binder emulsions include all types of polyacrylates such as polyacrylates, polymethacrylates, and styrene-acrylates or methacrylates wherein the glass transition temperature is greater than 50° C. and the particle size of the polymer emulsion is under 500 nm. Using of the high Tg latex polymer emulsions described herein allows a high pigment load, but without negatively influencing jetting.

### FIELD OF THE INVENTION

The present invention relates to pigment ink formulation and method for thermal inkjet printing to improve photo image surface toughness and plain paper color gamut.

Ink jet printing is a well known process and generally comprises ejecting a droplet of an ink composition through a fine nozzle to record images on a surface of a recording medium. Typically, paper recording mediums are employed although other polymer based film recording mediums have also been used. High quality printing and relatively low noise operation have made ink jet printers particularly advantageous.

Dyes and/or pigments are typically used as colorants in ink jet ink compositions. While dyes often provide very good color properties immediately after printing, they are often light sensitive so that printed images tend to fade after time. Dyes can also remain water soluble after printing, whereby printed images smear when contacted with moisture.

Pigment inks, on the other hand, provide excellent light fastness and water fastness. So they are increasingly becoming more prevalent in inkjet printing applications. Unlike dye based inkjet inks, pigment inks contain insoluble colorant particles. When the ink is printed on to the photo substrates, most of the pigment particles stay on the surface with dispersant, humectants and other additives; leaving it susceptible to handling issues such as smudge, smear and scratch. Adding a film forming binder of low glass transition temperature (Tg) is a known answer to increasing ink resistance to handling issues. However, such low Tg binders negatively influence jetting and reliability.

The present invention specifically focuses on use of binders of Tg greater than ambient temperature to allow a high load, but without negatively influencing jetting. Prior disclosures that included the use of high Tg binders required the use of a fuser to achieve its desired function. Surprisingly, Applicants have found that use of the type of high Tg latex binders described herein does not require the use of a fuser to achieve the desired ink toughness. So jetting and reliability are not compromised and the desired image toughness is achieved.

### SUMMARY OF THE INVENTION

It is therefore an object of the present invention to provide improved ink jet ink compositions. It is a more specific object of the invention to provide ink jet ink compositions which exhibit good optical density and good print quality. It is a further object of the invention to provide such ink jet ink compositions which also exhibit improved rub resistance. It is a related object of the invention to provide latex binders for use in ink jet ink compositions and, particularly, for improving rub resistance of ink jet ink compositions. It is a further object of the invention to provide improved methods for ink jet printing, which methods employ pigment-containing ink jet ink compositions having latex binder therein.

These and additional objects and advantages are provided by the present invention. In a first embodiment, the invention is directed to aqueous ink jet ink compositions which comprise pigment, humectant, dispersant, a latex binder, and an aqueous carrier. The latex binders described in the current invention can include all types of latex polymer emulsions. The latex polymer emulsions are preferably selected from the group consisting of polyacrylate, polymethacrylate, styrene acrylate, and methacrylate, and mixtures thereof wherein the glass transition temperature (Tg) is greater than 50° C. and the particle size of the latex polymer emulsion is less than 500 nm.

The aqueous ink jet ink compositions can contain latex emulsions at loadings of up to 7.5% by weight. The pigment ink formulations containing high percentage of binder polymers significantly improves the toughness of the printed image on photo papers and subsequently improves plain paper color gamut for up to 50K units. All this is accomplished without the use of any post heat process.

In a further embodiment, the invention is directed to methods of ink jet printing, which methods comprise ejecting a droplet of an aqueous ink jet ink composition through a nozzle and onto a surface of a paper recording medium. These methods provide printed recorded mediums having an advantageous combination of good optical density, good print quality and good rub resistance.

All percentages and ratios, used herein, are “by weight” unless otherwise specified. All molecular weights, used herein, are weight average molecular weights unless otherwise specified.

Additional embodiments, objects and advantages of the present invention will be further apparent in view of the following detailed description.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a graph illustrating the plain paper color gamut improvement of aqueous ink jet ink compositions of the present invention.

The exemplifications set out herein illustrate one preferred embodiment of the invention, in one form, and such exemplifications are not to be construed as limiting the scope of the invention in any manner.

### DESCRIPTION OF THE PREFERRED EMBODIMENT

The aqueous ink jet ink compositions and the ink jet printing methods according to the present invention provide printed recording mediums which exhibit good optical density, good print quality, good rub resistance, and improved plain paper color gamut up to 50K units.

The aqueous ink jet ink compositions comprise pigment, humectant, dispersant and latex binder in an aqueous medium. The aqueous medium may comprise water, preferably distilled and/or deionized water, or may comprise water in combination with one or more water-miscible organic solvents. In a preferred embodiment, the aqueous medium is deionized water

A wide variety of organic and inorganic pigments are known in the art for use in ink jet printing systems and are suitable for use in the compositions of the present invention, alone or in combination. The pigment dispersion particles must be sufficiently small to permit free flow of the ink through the ink jet printing device, and particularly the ink jet print nozzles, which typically have diameters in the range of from about 10 to about 50 μm, and more typically of about 30 μm or less. The particle size of the pigment should also be selected to maintain pigment dispersion stability in the ink, and it is generally desirable to use smaller sized particles for maximum color strength. Accordingly, pigment dispersion particles having a size in the range of from about 50 nm to about 5 μm, and more preferably less than about 1 μm, are preferred.

Pigments which are suitable for use in the present compositions include, but are not limited to, azo pigments such as condensed and chelate azo pigments; polycyclic pigments such as phthalocyanines, anthraquinones, quinacridones, thioindigoids, isoindolinones, and quinophthalones; nitro pigments, daylight fluorescent pigments; carbonates; chromates; titanium oxides; zinc oxides; iron oxides and carbon black. In one embodiment, the pigment is other than a white pigment, such as titanium dioxide. Preferred pigments employed in the ink composition include carbon black and pigments capable of generating a cyan, magenta and yellow ink. Suitable commercially available pigments include, for example, Pigment Red 81, Pigment Red 122, Pigment Yellow 13, Pigment Yellow 14, Pigment Yellow 17, Pigment Yellow 74, Pigment Yellow 83, Pigment Yellow 128, Pigment Yellow 138, Pigment Orange 5, Pigment Orange 30, Pigment Orange 34, Pigment Blue 15:4 and Pigment Blue 15:3. The pigments may be prepared via conventional techniques.

The ink compositions also include a dispersant, typically for dispersing the pigment therein. The dispersant may be polymeric or nonpolymeric. The term “polymeric dispersant” as used herein, is meant to include homopolymers, copolymers, terpolymers and immiscible and miscible polymer blends. Suitable non-polymeric dispersants include naphthalene sulfonic acid, sodium lignosulfate and glycerol stearate. Numerous polymeric dispersants are known in the art and are suitable for use in the present compositions The polymeric dispersant may comprise a random polymer or a structured polymer, for example a block copolymer and/or branched polymer, or mixtures thereof, and the dispersant polymer may be anionic, cationic or nonionic in nature. Suitably, polymers having both hydrophilic sections for aqueous compatibility and hydrophobic sections for interaction with the pigment are preferred.

A further component of the aqueous ink jet compositions is the humectant, Humectants for use in ink jet ink compositions are known in the art and are suitable for use herein. Examples include, but are not limited to, alcohols, for example, glycols such as 2,2′-thiodiethanol, glycerol, 1,3-propanediol, 1,5-pentanedio, polyethylene glycol, ethylene glycol, diethylene glycol, propylene glycol and tetraethylene glycol; pyrrolidones such as 2-pyrrolidone; N-methyl-2-pyrrolidone; N-methyl-2-oxazolidinone; and monoalcohols such as n-propanol and iso-propanol.

Preferably the humectants are selected from the group consisting of alcohols, glycols, pyrrolidones, and mixtures thereof. Preferred humectants include 2,2′-thiodiethanol, glycerol, 1,3-propanediol, 1,5-pentanediol, polyethylene glycol, ethylene glycol, diethylene glycol, triethylene glycol, propylene glycol, tetraethylene glycol, 2-pyrrolidone, n-propanol and mixtures thereof. In one preferred embodiment, the humectant is selected from the group consisting of triethylene glycol, glycerol, propylene glycol, 2-pyrrolidinone, low molecular weight (i.e., MW≦400) polyethylene glycol, and mixtures thereof.

The latex binder is employed in the ink jet ink compositions in order to improve the water-fastness of a printed recording medium, particularly as measured by wet-rub resistance and the picture quality, as measured for example, by the plain paper color gamut. The latex binder is particularly advantageous in that it improves the rub resistance while improving both the print quality and optical density. Additionally, the latex binder resists film formation on the nozzle plate and allows the ink compositions to properly eject from the nozzles during the printing operation Accordingly, clogging of the nozzles by the ink composition is prevented.

The latex binder in the present invention is preferably in the form of an emulsion. The latex polymer emulsions described in current invention include all types of polyacrylates, polymethacrylates, styrene-acrylates and methacrylates wherein the glass transition temperature (Tg) is greater than 50° C. and the particle size of the polymer emulsion is under 500 nm. Preferred latex polymer emulsions include styrene-alkyl acrylate copolymers such as styrene-butyl acrylate and alkyl methacrylate-alkyl acrylate copolymers such as methyl methylacrylate-butyl acrylate.

The latex binder emulsion is formed by emulsion polymerization of selected components Particularly, a combination of acrylates, methacrylates, styrenic monomers, or other vinyl type monomers and mixtures thereof are employed in combination with an emulsifier and an initiator

The reaction medium for preparing the latex binder employs an emulsifier and may also include anionic groups on the polymer backbone in order to obtain the desired particle size. Particularly, the latex binder has an average particle size as measured by a Honeywell UPA 150 light scattering instrument of less than 500 nm, preferably from about 50 nm to about 350 nm, and more preferably from about 100 nm to about 300 nm.

Various anionic monomers are known in the art and are suitable for use in adding anionic functional groups to the latex binder of the present compositions. In a preferred embodiment, the anionic monomer comprises methacrylic acid, acrylic acid, styrene sulfonic acid and/or a salt thereof Sodium salts of methacrylic acid and/or acrylic acid are particularly preferred. The anionic monomer may be employed in conventional amounts, and preferably in an amount of from about 0.1% to about 5% by weight of the emulsion polymerization components.

Various emulsion polymerization emulsifiers are also known in the art and suitable for use in the present methods. However, in the preferred embodiment, the emulsifier is an alkyl sulfate, and more preferably lauryl sulfate sodium salt. Suitably, the emulsifier may be employed in conventional amounts and preferably in an amount of from 0.1% to about 5% by weight of the emulsion polymerization components.

The emulsion polymerization is conducted in accordance with conventional polymerization techniques, for example in a semi batch process. The latex polymer binder is synthesized by free radical initiated polymerization, and any free radical initiator known in the art may be employed. Preferably, the initiator comprises a peroxy compound such as a persulfate, peroxide, or the like. Persulfate initiators such as ammonium persulfate are particularly preferred. The initiator may be employed in conventional amounts and suitably is employed in an amount of from about 0.01 to about 5 weigh percent, based on the weight of the emulsion polymerization components.

The monomers in the emulsion polymer composition can be selected from any acrylates, methacrylates, styrenic monomers, and vinyl monomers. However, it is preferred that the polymer composition contain at least one high Tg hydrophobic monomer. The monomer is considered to be high Tg if the Tg of the homopolymer of that monomer is ≧500° C. It is preferred that the monomer composition of the polymer contain between about 5% and 100% of the high Tg monomer based on weight of monomer components.

The aqueous ink jet ink compositions according to the present invention may employ the pigment, humectant, dispersant and latex binder in amounts suitable for obtaining desired print properties In preferred embodiments, the aqueous compositions comprise, by weight, from about 1% to about 20% pigment, from about 5% to about 50% humectant, from about 0.01% to about 10% dispersant, and from about 1% to about 20% latex binder. More preferably, the compositions comprise, by weight, from about 1% to about 10% pigment, from about 10% to about 30% humectant, from about 0.1% to about 5% dispersant, and from about 1% to about 10% latex binder. Even more preferred are compositions comprising, by weight, from about 4% to about 8% pigment, from about 15% to about 25% humectant, from about 0.1% to about 4% dispersant, and from about 2.5% to about 7.5% latex binder.

The ink compositions may further include conventional additives known in the art For example, the compositions may comprise one or more biocides to allow long term stability. Suitable biocides include benz-isothiazolin-one, methyl-isothiazolin-one, chloro-methyl-isothiazolin-one, sodium dihydroacetate, sodium sorbate, sodium 2-pyridinethiol-1-oxide, sodium benzoate and sodium pentachlorophenol. Examples of commercially available biocides are Zolidine™ Proxel™, Givguard™, Canguard 327™ and Kathon® PFM. The compositions may further include fungicides, bactericides, penetrants, surfactants, anti-kogation agents, anti-curling agents and/or buffers, various examples of which are known in the art The inkjet ink compositions suitably have a pH of from about 7.5 to about 8.5.

The aqueous ink jet ink compositions may be prepared in accordance with conventional processing techniques. Typically, the pigment is combined with the dispersant to provide a pigment dispersion which is then combined with additional components of the compositions. The compositions may be employed in ink jet printing methods in a conventional manner, wherein a droplet of the ink composition is ejected through a printhead nozzle in response to an electrical signal and onto a surface of a paper recording medium. Optionally, the printed image can be heated to improve its rub resistance. For example, a recording medium may be passed through a heating zone at a temperature greater than about 70° C., preferably greater than about 100° C., to improve the wet rub resistance of printed images thereon.

In one embodiment of ink jet printing methods according to the present invention, a droplet of an aqueous ink jet ink composition is ejected through a printhead nozzle and onto a surface of a paper recording medium, after which the paper recording medium with the aqueous ink jet ink composition on a surface thereof is passed through a fuser system at a temperature greater than about 100° C. for about 5 to about 100 seconds. By passing the printed recording medium through the fuser system, the wet-rub resistance of an ink composition is substantially improved while maintaining good print quality and optical stability. In a preferred embodiment, the fuser system is operated at a temperature greater than about 100° C. and the paper recording medium passes through the fuser system for about 20 to about 60 seconds.

This method may be employed with various types of paper recording mediums, including plain papers such as copy paper, report paper and bond paper, as well as pretreated papers such as coated and glossy papers.

In one embodiment of these methods, pressure is applied to the paper recording medium in the fuser system. For example, pressure may be applied to one side of the recording medium or, more preferably, to both sides of the recording medium. Suitable pressures applied to the paper recording medium in the fuser system are in the range of from about 15 psi to about 30 psi, and more preferably from about 18 psi to about 26 psi.

Importantly, Applicants have found that adding 2.5% to 7.5% of the high Tg latex binders described herein to pigment inks results in significant improvements in photo image toughness. Adding 2.5% to 7.5% of the high Tg latex binders to pigment inks also results in up to a 50K units of improvements in plain paper color gamut. Even when 7.5% of high Tg binder material is added into the ink formulation to bring the total solids up to 14%, a high quality of jetting for thermal inkjet printers remains. An optional fuser gives an added level of ink toughness for smudge, smear, and scratch.

Typical ink formulations are shown in the following examples. The humectants in the following examples are triethylene glycol, glycerol, propylene glycol, 2-pyrrolidinone, and low molecular weight (i.e., MW of ˜200) of polyethylene glycol. Percentage amounts are by weight of the ink. The pigment dispersions employed in the examples are C. I. pigment blue 15:3, C. I. pigment red 122, C. I. pigment yellow 155, and C. I. pigment yellow 74.

Formulation 1:

| | |
|---|---|
| Pigment dispersion: | 6.0% pigment |
| (Cyan, magenta, or yellow) | |
| Humectants: | 20% |
| Biocide: | 0.1% |
| Surfynol ® 465 | 0.7% |
| Balance D.I. Water | |

Formulation 2:

| | |
|---|---|
| Pigment dispersion: | 6.0% pigment |
| (Cyan, magenta, or yellow) | |
| Acrylate binder | 2.5% |
| Humectants: | 20% |
| Biocide: | 0.1% |
| Surfynol ® 465 | 0.7% |
| Balance D.I. Water | |

Formulation 3:

| | |
|---|---|
| Pigment dispersion: | 6.0% pigment |
| (Cyan, magenta, or yellow) | |
| Acrylate binder | 5.0% |
| Humectants: | 20% |
| Biocide: | 0.1% |
| Surfynol ® 465 | 0.7% |
| Balance D.I. Water | |

Formulation 4:

| | |
|---|---|
| Pigment dispersion: | 6.0% pigment |
| (Cyan, magenta, or yellow) | |
| Acrylate binder | 7.5% |
| Humectants: | 20% |
| Biocide: | 0.1% |
| Surfynol ® 465 | 0.7% |
| Balance D.I. Water | |

Process and Method, The pigment inks are formulated with 0% to 7.5% of a latex binder polymer emulsion. The inks were printed onto Lexmark developed porous media, Lexmark Perfect Finished photo media and three types of plain papers, Hammermill® LP, Boise Cascade® X9000, and Hammermill® Relay MP. Lexmark thermal inkjet printer was used to evaluate the jetting properties and generate the print samples.

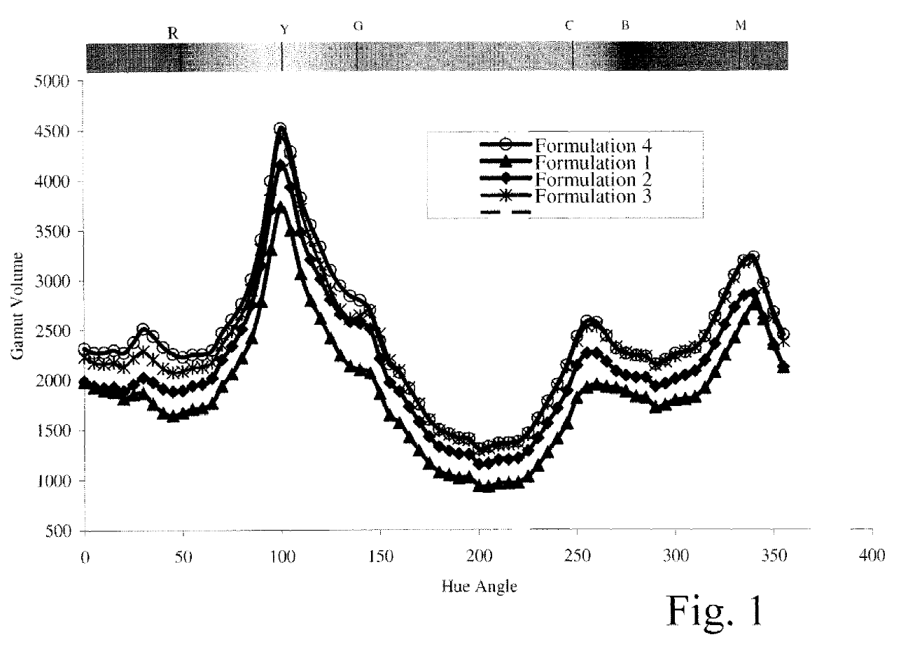

When ink containing high latex binder was printed onto the substrates, pigment and binder form a film together The pigment was fixed with binder to the substrates and it results in a significant improvement in photo smear, smudge, and scratch. Image surface was very tough and water proof. Because of the higher solid content in the ink, when ink was printed onto the plain paper, pigment and latex binder mixture would stay more on the plain paper surface and less penetration. It showed 50K units in increasing plain paper color gamut (see FIG. 1)

A laser fuser was used for heating the printed photo image immediately after the printing. The temperature of the laser fuser was set between 150 to 180° C. The application of laser fuser added more effects on photo image toughness to therefore, significantly improve the photo image smear, smudge and scratch.

Inks jet very well on thermal inkjet printer with up to 7.5% of high Tg latex binder added onto the pigment inks (6% pigment loading, by weight). The ink formulations containing latex binders with Tg lower than 50° C. did not jet well in thermal inkjet printers (see Tables 1 and 2 below).

TABLE 1
The performance of ink formulation with different Tg of commercial
binders

| | | % binder in | Jetting | Surface | Plain paper |
|---|---|---|---|---|---|
| Acrylate emulsion | Tg (° C.) | ink | performance | Toughness | gamut |
| Joncryl ® 77 | 21 | 2.5%–7.5% | Did not jet | NA | NA |
| Joncryl ® ECO 2177 | 21 | 2.5%–7.5% | Did not jet | NA | NA |
| Joncryl ® HRC 1663 | −55 | 2.5%–7.5% | Did not jet | NA | NA |
| Joncryl ® DFC 3040 | 21 | 2.5%–7.5% | Did not jet | NA | NA |
| Joncryl ® 660 | 27 | 2.5%–7.5% | Did not jet | NA | NA |
| Acryjet ® 3666 | 12.26 | 2.5%–7.5% | Did not jet | NA | NA |

TABLE 2
Performance of ink formulation with different Tg of experimental latex
binders

| | | | | | | Theoretical | % Binder | Jetting |
|---|---|---|---|---|---|---|---|---|
| Polymer ID | % Surf. | % SSA | % APS | Monomer 1 | Monomer 2 | Tg(Celsius) | in Ink | Performance |
| Group 1 | 0 | 0.25 | 0.6 | Styrene | Butyl Acrylate | −10 | 2.5% to 7.5% | Did Not Jet |
| EA-B-638 | | | | | | | | |
| EA-B-640 | 0 | 0.25 | 0.6 | Styrene | Butyl Acrylate | 50 | Up to 7.5% | Jet Well |
| Group 2 | 0.75 | 0 | 0.6 | Styrene | Butyl Acrylate | −10 | 2.5% to 7.5% | Did Not Jet |
| EA-B-639 | | | | | | | | |
| EA-B-641 | 0.75 | 0 | 0.6 | Styrene | Butyl Acrylate | 50 | Up to 7.5% | Jet Well |
| Group 3 | 0 | 0.25 | 0.6 | Methyl Methacrylate | Butyl Acrylate | −10 | 2.5% to 7.5% | Did Not Jet |
| EA-B-642 | | | | | | | | |
| EA-B-644 | 0 | 0.25 | 0.6 | Methyl Methacrylate | Butyl Acrylate | 50 | Up to 7.5% | Jet Well |
| EA-B-673 | 0 | 0.25 | 0.6 | Methyl Methacrylate | Butyl Acrylate | 65 | Up to 7.5% | Jet Well |
| EA-B-671 | 0 | 0.25 | 0.6 | Methyl Methacrylate | Butyl Acrylate | 88 | Up to 7.5% | Jet Well |
| Group 4 | 0.75 | 0 | 0.6 | Methyl Methacrylate | Butyl Acrylate | −10 | 2.5% to 7.5% | Did Not Jet |
| EA-B-643 | | | | | | | | |
| EA-B-645 | 0.75 | 0 | 0.6 | Methyl Methacrylate | Butyl Acrylate | 50 | Up to 7.5% | Jet Well |
| EA-B-674 | 0.75 | 0 | 0.6 | Methyl Methacrylate | Butyl Acrylate | 65 | Up to 7.5% | Jet Well |
| EA-B-672 | 0.75 | 0 | 0.6 | Methyl Methacrylate | Butyl Acrylate | 88 | Up to 7.5% | Jet Well |

In the table above % surf. refers to the weight percent of surfactant in the emulsion polymer composition. In this case, the surfactant is the sodium salt of dodecyl sulfate. The term % SSA refers to the weight percent of styrene sulfonic acid sodium salt in the polymer composition. The term % APS refers to the weight percent of initiator or in this case ammonium persulfate. Monomer 1 is the high Tg monomer in the polymer composition and monomer 2 is a lower Tg monomer used to manipulate the Tg to different levels.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An aqueous ink jet ink composition comprising, by weight, from about 1% to about 20% pigment, from about 5% to about 50% humectant, from about 0.01% to about 10% dispersant, from about 1% to about 10% of latex binder having a glass transition temperature (Tg) greater than 50° C., and an aqueous carrier.

2. The aqueous ink jet ink composition of claim 1 wherein said latex binder is an emulsion selected from the group consisting of polyacrylates, polymethacrylates, styrene-acrylate copolymers, styrene-methacrylate copolymers, and mixtures thereof.

3. The aqueous ink jet ink composition of claim 2 wherein the average particle size of said latex emulsion is less than 500 nm.

4. The aqueous ink jet ink composition of claim 3 comprising, by weight, from about 1% to about 10% pigment, from about 10% to about 30% humectant, from about 0.1% to about 5% dispersant, and from about 1% to about 10% of said latex emulsion.

5. The aqueous ink jet ink composition of claim 4 comprising, by weight, from about 4% to about 8% pigment, from about 15% to about 25% humectant, from about 0.1% to about 4% dispersant, and from about 2.5% to about 7.5% of said latex emulsion.

6. The aqueous ink jet ink composition of claim 5 wherein the average particle size of said latex emulsion is from about 50 to about 350 nm.

7. The aqueous ink jet ink composition of claim 6 wherein the average particle size of said latex emulsion is from about 100 to about 300 nm.

8. The aqueous ink jet ink composition of claim 3 wherein said latex emulsion has a glass transition temperature (Tg) from greater than 50° C. degree to about 100° C.

9. The aqueous ink jet ink composition of claim 3 wherein said latex emulsion is comprised of styrene-alkyl acrylate copolymers.

10. The aqueous ink jet ink composition of claim 9 wherein said styrene-alkyl acrylate copolymer is styren butyl acrylate.

11. The aqueous ink jet ink composition of claim 3 wherein said latex emulsion is comprised of alkyl methacrylate-alkyl acrylate copolymers.

12. The aqueous ink jet ink composition of claim 11 wherein and wherein said alkyl methacrylate-alkyl acrylate copolymer is methyl methylacrylate-butyl acrylate.

13. The aqueous ink jet ink composition of claim 1 wherein the humectant is selected from the group consisting of alcohols, glycols, pyrrolidones, and mixtures thereof.

14. The aqueous ink jet ink composition of claim 13 wherein the humectant is selected from the group consisting of triethylene glycol, glycerol, propylene glycol, 2-pyrrolidinone, low molecular weight polyethylene glycol, and mixtures thereof.

15. A method of ink jet printing, comprising ejecting a droplet of an aqueous ink jet ink composition through a nozzle and onto a surface of a paper recording medium, the aqueous ink jet ink composition comprising, by weight, from about 1% to about 20% pigment, from about 5% to about 50% humectant, from about 0.01% to about 10% dispersant, and from about 1% to about 10% of latex binder having a glass transition temperature (Tg) greater than 50° C., and an aqueous carrier.

16. The method of claim 15 wherein said latex binder is an emulsion selected from the group consisting of po yacrylates, polymethacrylates, styrene-acrylates, styrene-methacrylates, and mixtures thereof.

17. The method of claim 16 wherein the average particle size of said latex emulsion is less than 500 nm.

18. The method of claim 17 wherein the humectant is selected from the group consisting of alcohols, glycols, pyrrolidones, and mixtures thereof.

19. The method of claim 18 wherein the humectant is selected from the group consisting of triethylene glycol, glycerol, propylene glycol, 2-pyrrolidinone, low molecular weight polyethylene glycol, and mixtures thereof.
